(19) United States
(12) Patent Application Publication
(10) Pub. No.: US 2008/0059120 A1
(43) Pub. Date: Mar. 6, 2008

(54) USING FAULT HISTORY TO PREDICT REPLACEMENT PARTS

(76) Inventors: Fei Xiao, Penfield, NY (US); Rajinderjeet Singh Minhas, Penfield, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/468,443

(22) Filed: Aug. 30, 2006

(51) Int. Cl. G21C 17/00

(52) U.S. Cl. 702/184; 702/187

(57) ABSTRACT

Embodiments herein include a method, computer program, etc., that establishes a first database of part replacement and fault occurrence history based on maintenance records and device data for a plurality of very similar or identical devices (fleet of identical (e.g., same model number) devices, such as electrostatic printing devices). The method creates a model based on information within the first database that links sequences of faults to specific replacement parts for the plurality of identical devices. In addition, the method can maintain a second database of repair history for a specific device within the fleet. This allows the method to predict which part or parts (repair parts) are needed for the specific device by applying the model to a sequence of fault codes for the specific device. In addition to the fault codes, the model can also consider the history of the specific device within the second database.

### BACKGROUND

Embodiments herein generally relate to a method for remotely predicting which parts a service technician will need when performing a service call.

As companies strive to provide unprecedented levels of reliability and uptime to their customers, it is becoming increasingly important to quickly respond to, and even anticipate, problems in the field and resolve the problem and replace the faulty parts in a timely fashion. Service cost and machine down time will be reduced if customer service engineers (CSEs) have the knowledge of what parts to bring to service calls.

### SUMMARY

In order to effectively utilize data for diagnostics and predict what parts to use on service calls, it is necessary to combine the copious amount of raw information embedded in service databases and machine generated databases. The following describes a process of utilizing automated tools for the extraction and analysis of the data for the connected machine population and to provide recommendations for part replacement.

The process starts with identification and connection to the appropriate data sources, then the process queries servers for information such as unscheduled maintenance (UM), part replacement, and the associated fault code occurrences generated by devices. Advanced algorithms like association mining, and Bayesian networks can be used to build models and generate rules for the prediction of part replacement probability. These models/rules can be updated periodically to capture the changes due to software and hardware upgrades. Before they go on a service call to service a particular machine with a given Serial Number, customer service engineers (CSEs) and field engineers (FE) can run these models/rules by utilizing machine fault history leading to the unscheduled maintenance and customer input during the unscheduled maintenance initiation process.

Thus, embodiments herein include a method, computer program, etc., that establishes a first database of part replacement and fault occurrence history based on maintenance records and machine data for a plurality of very similar or identical devices (fleet of identical (e.g., same model number) devices, such as electrostatic printing devices). The method creates a model based on information within the first database that links a sequence of faults to specific replacement parts for the plurality of similar devices. In addition, the method can maintain a second database of repair history for a specific device within the fleet. This allows the method to remotely predict which part or parts (repair or replacement parts) are needed for the specific device by applying the model to a sequence of fault codes for the specific device. In addition to the fault codes, the model can also consider the history of the specific device within the second database.

The method can create the model by performing data mining of the information within the first database (e.g., attribute selection, decision tree, association mining, Bayesian network, and/or rule extraction). The process of creating the model can comprise an iterative process. In other words, the process of creating the model identifies patterns within the information within the first database. The remotely predicting process comprises matching patterns of the history of the specific faulty device (and/or the current history of fault codes) with the patterns within the information of the first database.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic diagram of the processing accomplished by embodiments herein;

FIG. 2 is a flow diagram illustrating embodiments herein; and

FIG. 3 is a schematic diagram of a system embodiment.

### DETAILED DESCRIPTION

The embodiments herein allow companies to boost productivity and reliability of their devices (such as copiers, printers, etc.) with expanded remote customer support. One feature that allows the detecting and diagnosing of problems in the field is the ability to remotely collect and monitor machine data (NVM (non-volatile memory), fault codes, sensor, actuator time series etc.) and generate actions from analyzing the data. For purposes of this application “remote” prediction and data collection/analysis is done in a physically separate location from the device in question, such as a different physical location, different room, different building, different town, city, state, or country, etc. Thus, when the “remote” prediction is performed, the user or service personnel is physically separated from the device in need of repair and does not have physical access to the device that is in need of repair (and cannot personally inspect the device to make a repair prediction). Instead, because the prediction for which parts will be required is being performed “remotely” (without physical access to the device) the need for proper prediction is more important because some travel must be included in the repair process. If an incorrect part is delivered to (or carried by) the technician, inefficiencies in the repair process would be incurred as the travel would be duplicated. Remote data collection is now being done for many production systems. As the available information from these and other products grows, it becomes possible for service personnel to use the information to make more accurate diagnostics and prognostics.

Data mining is the process of discovering useful patterns in data that are hidden and unknown in normal circumstances. Useful patterns in data for example may disclose information on event frequency, magnitude, duration, and cost. Data mining draws from several fields, including machine learning, statistics, and database design. It uses techniques such as clustering, associative rules, visualization, and probabilistic graphical dependency models to identify hidden and useful structures in large databases.

In this disclosure, a model is developed using data mining and is used to accurately identify and predict what parts should be brought to a service call when an unscheduled maintenance call is initiated. The embodiments herein integrate existing relevant data from various databases, apply data mining techniques to develop a model, and run the model before a CSE/FE goes out on a service call.

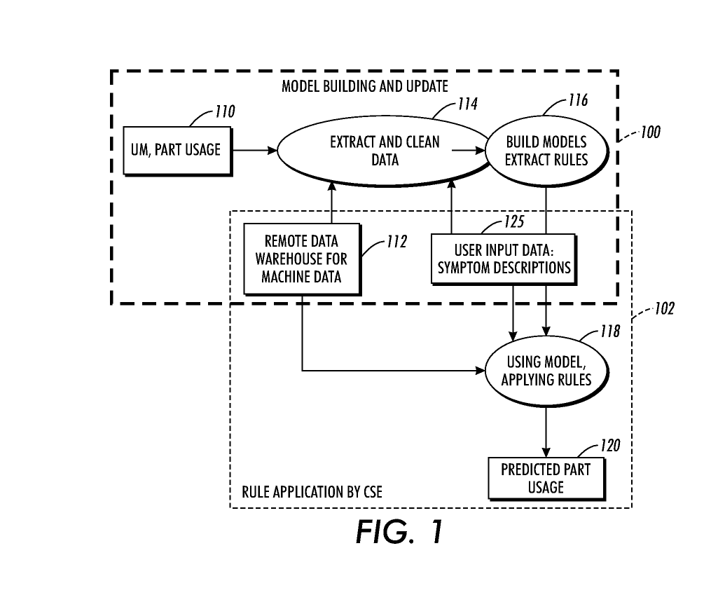

One non-limiting example of this process is shown in FIG. 1. There are two general steps in the process: model building and automatic updating by the product development team 100 and model/rule application by field service personnel 102. In the model building process 100, the method connects databases with service data 110 and machine generated and maintained data 112. From those data sources 110, 112, the method links fault occurrences and frequency in a period before and after an unscheduled maintenance with the parts replaced during the service calls. Thus, for each part replacement, the fault and the number of occurrences can be given. This type of information will be used to build the model(s). When available, device behavior/symptom description from users will also be used as input to build the model.

After the raw data is obtained the data is cleaned to extract useful measures in item 114. Various data mining techniques such as attribute selection, decision tree, Bayesian network and association rule extraction etc. can be applied to build models (in item 116) to predict the part replacement probability given the fault history lead up to the service call generation (see U.S. Pat. Nos. 7,051,293 and 6,973,459, the complete disclosures of which are incorporated herein by reference, which discuss data mining, model creation and model application). The model building and verification process is iterative. This allows the method to refine the data used and select the appropriate techniques to make accurate prediction. The model will also incorporate machine information such as software and hardware configuration to make it more accurate. As the machine and machine parts' performance evolves over the life cycle of the product, the model will be updated to reflect the current state of the fleet.

Once built and verified, the model will be made available to field service personnel in item 102. After the dispatch but before the service trip, the CSEs will be able to extract the fault history of the (connected) faulty machine and get the information about the probability of part replacements for the service call by using the model in item 118. This allows the CSE a prediction (item 120) of what part to bring or order for this call. For example, if the model finds that the frequency and/or sequence of certain faults lead to high occurrences of certain part(s) replacement(s), then applying the model to the fault data for a machine with outstanding UM calls will generate the probability list of part replacements (X % for Part A; Y % for Part B . . . ).

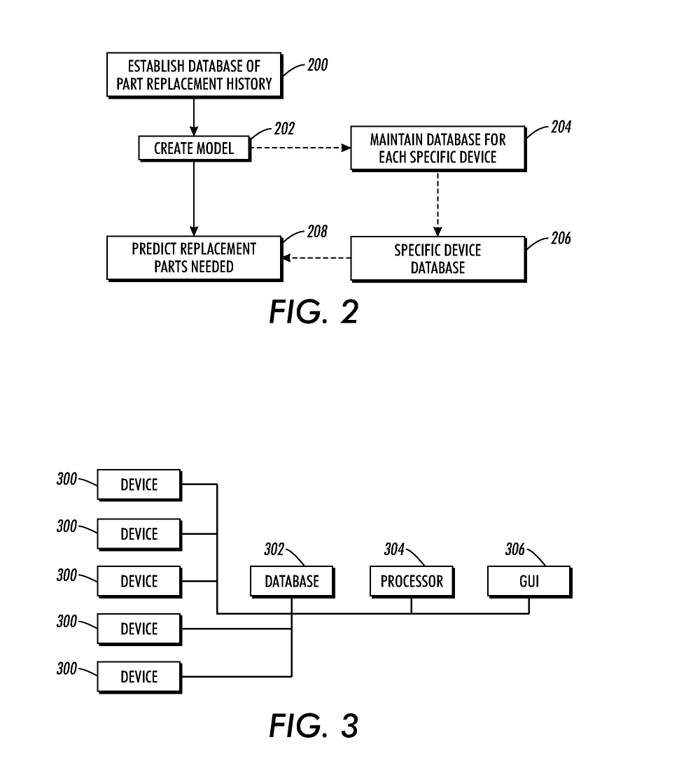

Embodiments herein include a method, computer program, etc., that, as shown in item 200 of FIG. 2, establishes a first database of part replacement and fault occurrence history based on maintenance records and device maintained data for a plurality of very similar or identical devices (e.g., fleet of identical (e.g., same model number) devices, such as electrostatic printing devices, etc.). The level of similarity between the devices maintained in the database can vary depending upon each different application of embodiments herein. Thus, the similarity can be very strict (e.g., where only the same model number is a considered a “similar” device) or can be very loose (where all printers are considered one device, while personal computers are considered a dissimilar device from printers). The method creates a model (item 202) based on information within the first database that links sequences of faults to specific replacement parts for the plurality of identical devices. In addition, the method can maintain a second database of repair history for a specific device within the fleet in item 204.

This allows the method to predict which part or parts (repair parts) are needed for the specific device by applying the model to fault codes for the specific device in item 208. In addition to the fault code, the model can also consider the history of the specific device within the second database, as shown by item 206. Thus, for example, one way in which the model can be used is merely by supplying a machine Serial Number, an error code, fault description, description of the fault symptoms, etc. Then the model can supply a list of the most likely parts that will be needed. Alternatively, the processing can be substantially more sophisticated and can consider the pattern of error/fault codes (or operating conditions such as temperatures, delay times, number of resets/recalibrations, etc.) that have been recently occurring in the specific faulty device that is to be repaired. The model can compare this pattern of error/fault codes and operating conditions to the results from the data mining to establish similarities between the pattern experienced by the faulty machine and the history of repair parts associated with such patterns in the model. One ordinarily skilled in the art would understand that the foregoing are merely examples and that the embodiments herein are not limited to these examples, that are supplied only to aid in the understanding of the invention.

The method can create the model in item 202 by performing data mining of the information within the first database (e.g., attribute selection, decision tree, Bayesian network, association rules, and/or rule extraction). The process of creating the model can comprise an iterative process. In other words, the process of creating the model identifies patterns within the information within the first database. The remotely predicting process in item 208 comprises matching patterns of the history of the specific faulty device (and/or the current sequence of fault codes) with the patterns within the information of the first database.

FIG. 3 is one non-limiting example of how various devices 300 in the fleet (in remote customer service usage) can be connected to at least one database 302 by way of wired or wireless (temporary or permanent) connections. The database 302 shown in FIG. 3 can represent the first or second databases discussed above and can contain the information about the fleet as well as the information about each individual device's fault and repair history. At least one processor 304 can be used to generate the model from the information in the database(s) and at least one graphic user interface 306 can be used to allow the service technician to interact with the model running on the processor 304 and obtain a prediction of part need.

One ordinarily skilled in the art would understand that the items and arrangement shown in FIG. 3 are merely examples and that the embodiments herein are not limited to these limited examples that are supplied only to aid in the understanding of the invention. For example, U.S. Patent Publication 2004/0181712 (the complete disclosure of which is incorporated herein by reference) describes a system which predicts device failures (as opposed to remotely predicting which repair parts are needed) in a distributed, networked system and the embodiments herein could utilize such a system in its operation. As another example of systems upon which embodiments here can operate include ones similar to that described in U.S. Patent Publication 2002/0007237 (the complete disclosure of which is incorporated herein by reference) which describes a system and method whereby diagnostic information from recorded transactions dynamically builds a knowledge base repository in an implemented central data system via the Internet. In addition to problem trends, returning or “unsuccessful” repair cases are tracked and are intelligently manipulated and factored into future repair recommendations. The knowledge base repository is created by a multitude of diagnostic transactions that will delineate diagnostic cases and scenario solutions upon request. In due course, the sophistication of the knowledge base will rapidly increase with each recorded transaction. Ultimately, the database will intelligently converge to optimum repair recommendations. The optimum level of intelligence would provide the most direct diagnostic solution via a plurality of requests processing (e.g., search engine, query processes, troubleshooting methods, or the like).

While some conventional solutions (such as 2002/0007237, discussed above) are utilized to perform a diagnosis of device failures at a repair shop, the present embodiments remotely utilize human generated “symptoms” (through text mining) and data generated by devices (if available) to perform diagnosis and predict what parts to bring to the customer site before the Customer Service Engineer (CSE) take the repair trip. The embodiments herein use existing data and knowledge through numerical data and text mining to predict what part(s) to replace and the probabilities of replacing them before the CSE get to the customer site. The economic benefit/penalty of bringing parts to customer site is a factor for deciding what and how many parts to bring to customer site: too many parts, a waste of resource; too few, CSE has to make additional trips. One potential data type for our application is failure code data streams before the failure. Data stream mining and text mining are powerful tools for applications that use the embodiments herein.

The word “printer” or “printing devices” as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

For example, the printers and devices described herein can include self-diagnostic features such as those described in U.S. Pat. No. 6,862,414, the complete disclosure of which is incorporated herein by reference. In U.S. Pat. No. 6,862,414, the diagnostic system operates in association with a document processing system. The diagnostic system can be part of a document processor, multifunction machine, printer, etc., or could be part of a general purpose computer server connected to the machine, or could be implemented as a stand alone appliance having appropriate plug in capability for operation with a variety of machines in many different environments. For illustration, the basic components of document processing system include a print engine which is served by a document feed and a scanner. A system controller provides operating control of the system in conjunction with a memory. An array of sensors can be distributed throughout the system to monitor the performance of the system at key points. The sensors generate current system data which can be stored in memory to provide historical and status data to assist in analysis of defects. Further, system performance data can be obtained by monitoring operating signals and other characteristics of the document processing system. For simplicity such monitoring function can be encompassed in the sensor array module.

The document processing system can include a wide variety of components and architectures. The diagnostic system can include an image quality analysis module which identifies and characterizes a defect in terms of quantitative parameters and generates key features of the defect for further analysis. Additionally, the user can be prompted to input additional features describing the defect, such as by the selection of one of a set of icons or images, or by answering a set of specific questions. The output of the image quality analysis module and the user input data can be adapted for use in a diagnostic engine by a preprocessor. The data can be processed in diagnostic engine to correlate the key features of the banding to a malfunction which is a possible source of the defect. A probability of causation can be evaluated and a recommended repair or service can be selected by the repair planning module. The results can be presented through user interface. The user interface may include a display screen and appropriate keypad.

The diagnostic controller can control and coordinate the operation of all of the modules. A memory can be provided in operative association with the processing components of the diagnostic system to store the algorithms and data used in the analysis and diagnosis. Memory may also be adapted to track the operation of the diagnostic system, by logging and categorizing data. In this manner a historic data base of error correction may be maintained for future reference by diagnostic engine. The diagnostic system can be adapted to consider all of the data generated by the image quality analysis module and eventually, using historical and experimental data relating to the causes of defects and data relating to the service fixes for such causes, present instructions to accomplish a recommended service agenda.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein should not be implied or imported from any above example as limitations to any particular order, number, position, size, shape, angle, color, or material.

1. A method comprising:
establishing a database of part replacement and fault occurrence history comprising device symptoms based on human generated maintenance records and device maintained data for a plurality of devices;
creating a model based on information within said database that links sequences of faults to specific replacement parts for said plurality of devices;
remotely predicting part need probabilities for a specific device by applying said model to faults for said specific device and to a history of said specific device, wherein said remotely predicting comprises matching a sequence of fault codes of said history of said specific device with patterns within said information within said database; and
outputting to a user a list of potential replacement parts and corresponding part need probabilities for each potential replacement part on said list,
wherein each of said part need probabilities comprises a percentage probability that a corresponding potential replacement part will be needed for said specific device.

2. The method according to claim 1, all the limitations of which are incorporated herein by reference, wherein said creating comprises data mining of said information within said database.

3. The method according to claim 1, all the limitations of which are incorporated herein by reference, wherein said creating comprises at least one of attribute selection, decision tree, Bayesian network, association mining and rule extraction.

4. The method according to claim 1, all the limitations of which are incorporated herein by reference, wherein said creating comprises an iterative process.

5. The method according to claim 1, all the limitations of which are incorporated herein by reference, wherein said creating comprises identifying patterns within said information within said database.

6. (canceled)

7. The method according to claim 1, all the limitations of which are incorporated herein by reference, wherein said remotely predicting comprises performing said predicting at a location physically separate from said specific device, such that a repair technician does not have physical access to said specific device.

8. A method comprising:
establishing a first database of part replacement and fault occurrence history comprising device symptoms based on human generated maintenance records and device maintained data for a plurality of identical devices;
creating a model based on information within said first database that links sequences of faults to specific replacement parts for said plurality of identical devices;
maintaining a second database of repair history for a specific device within said plurality of identical devices;
remotely predicting part need probabilities for said specific device by applying said model to faults for said specific device and to a history of said specific device within said second database, wherein said remotely predicting comprises matching a sequence of fault codes of said history of said specific device with patterns within said information within said first database; and
outputting to a user a list of potential replacement parts and corresponding part need probabilities for each potential replacement part on said list,
wherein each of said part need probabilities comprises a percentage probability that a corresponding potential replacement part will be needed for said specific device.

9. The method according to claim 8, all the limitations of which are incorporated herein by reference, wherein said creating comprises data mining of said information within said first database.

10. The method according to claim 8, all the limitations of which are incorporated herein by reference, wherein said creating comprises at least one of attribute selection, decision tree, Bayesian network, association mining and rule extraction.

11. The method according to claim 8, all the limitations of which are incorporated herein by reference, wherein said creating comprises an iterative process.

12. The method according to claim 8, all the limitations of which are incorporated herein by reference, wherein said creating comprises identifying patterns within said information within said first database.

13. (canceled)

14. The method according to claim 8, all the limitations of which are incorporated herein by reference, wherein said remotely predicting comprises performing said predicting at a location physically separate from said specific device, such that a repair technician does not have physical access to said specific device.

15. A method comprising:
establishing a first database of part replacement and fault occurrence history comprising device symptoms based on human generated maintenance records and device maintained data for a fleet of identical electrostatic printing devices;
creating a model based on information within said first database that links sequences of faults to specific replacement parts for said fleet;
maintaining a second database of repair history for a specific device within said fleet;
remotely predicting part need probabilities for said specific device by applying said model to faults for said specific device and to a history of said specific device within said second database, wherein said remotely predicting comprises matching a sequence of fault codes of said history of said specific device with patterns within said information within said first database; and
outputting to a user a list of potential replacement parts and corresponding part need probabilities for each potential replacement part on said list,
wherein each of said part need probabilities comprises a percentage probability that a corresponding potential replacement part will be needed for said specific device.

16. The method according to claim 15, all the limitations of which are incorporated herein by reference, wherein said creating comprises data mining of said information within said first database.

17. The method according to claim 15, all the limitations of which are incorporated herein by reference, wherein said creating comprises at least one of attribute selection, decision tree, Bayesian network, association mining and rule extraction.

18. The method according to claim 15, all the limitations of which are incorporated herein by reference, wherein said creating comprises an iterative process.

19. The method according to claim 15, all the limitations of which are incorporated herein by reference, wherein said remotely predicting comprises performing said predicting at a location physically separate from said specific device, such that a repair technician does not have physical access to said specific device.

20. A computer program product comprising:
a computer-usable data carrier storing instructions that, when executed by a computer, cause a computer to perform a method comprising:
establishing a database of part replacement and fault occurrence history comprising device symptoms based on human generated maintenance records and device maintained data for a plurality of devices;
creating a model based on information within said database that links sequences of faults to specific replacement parts for said plurality of devices;
remotely predicting part need probabilities for a specific device by applying said model to a fault for said specific device and to a history of said specific device, wherein said remotely predicting comprises matching a sequence of fault codes of said history of said specific device with patterns within said information within said database; and
outputting to a user a list of potential replacement parts and corresponding part need probabilities for each potential replacement part on said list,
wherein each of said part need probabilities comprises a percentage probability that a corresponding potential replacement part will be needed for said specific device.
